(19) United States
(12) Patent Application Publication
(10) Pub. No.: US 2022/0403658 A1
(43) Pub. Date: Dec. 22, 2022

(54) CONCRETE ROOFING SYSTEMS AND METHODS THEREOF

(71) Applicant: Siplast, Inc., Irving, TX (US)

(72) Inventors: Zachary Scott Taylor, Sheridan, AR (US); Kirk Matthew Goodrum, Arkadelphia, AR (US); Min Kyung Nam, Arkadelphia, AR (US)

(21) Appl. No.: 17/846,865

(22) Filed: Jun. 22, 2022

Related U.S. Application Data
(60) Provisional application No. 63/213,493, filed on Jun. 22, 2021.

(51) Int. Cl. E04D 5/14; E04D 5/06; E04D 5/08; C09J 5/00

(52) U.S. Cl. CPC E04D 5/148; E04D 5/06; E04D 5/08; C09J 5/00

(57) ABSTRACT

In some embodiments, roofing systems and methods thereof are disclosed. In some embodiments, the roofing system includes a roofing substrate comprising concrete and a top surface. In some embodiments, the roofing system includes a roofing membrane adhered to the roofing substrate. In some embodiments, the roofing system comprises a patterned adhesive on the top surface of the roofing substrate that adheres the roofing membrane to the roofing substrate, that has a spatter pattern, and that comprises a silane-terminated polymer.

### CROSS-REFERENCE TO RELATED APPLICATION

This application claims the benefit of priority to provisional application No. 63/213,493, filed Jun. 22, 2021, titled “CONCRETE ROOFING SYSTEMS AND METHODS THEREOF,” the entire disclosure of which is incorporated by reference herein.

### FIELD

The present disclosure relates to concrete roofing systems and methods.

### BACKGROUND

Some roofing systems include a roofing substrate that comprises concrete and a roofing membrane. In some of these roofing systems, venting channels may be needed to expel moisture and/or relieve vapor pressure from the roofing system.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

In some embodiments, a roofing system comprises a roofing substrate, wherein the roofing substrate comprises concrete, and wherein the roofing substrate comprises a top surface; a roofing membrane adhered to the roofing substrate; and an adhesive on the top surface of the roofing substrate, wherein the adhesive adheres the roofing membrane to the roofing substrate, wherein the adhesive has a spatter pattern, and wherein the adhesive comprises a silane-terminated polymer.

In some embodiments, a method of installation comprises obtaining an adhesive, wherein the adhesive comprises a silane-terminated polymer; obtaining a roofing membrane; applying the adhesive to a top surface of a roofing substrate so as to form a spatter pattern on the top surface of the roofing substrate, wherein the roofing substrate comprises concrete; and adhering the roofing membrane to the roofing substrate so as to form a roofing system.

In some embodiments, applying the adhesive to the top surface of the roofing substrate comprises using air pressure, spraying, splashing, or any combination thereof.

In some embodiments, the method of installation comprises using a rake to compress the roofing membrane to the roofing substrate.

In some embodiments, the method of installation comprises using a roller to compress the roofing membrane to the roofing substrate.

In some embodiments, the roofing membrane comprises thermoplastic polyolefin (TPO), polyvinyl chloride (PVC), Styrene-Butadien-Styrene (SBS) modified bitumen, polymethylmethacrylate (PMMA), or any combination thereof.

In some embodiments, forming the spatter pattern on the top surface of the roofing substrate comprises forming an increased number of venting channels as compared to a roofing system with a striped pattern adhesive.

In some embodiments, the adhesive covers from 40% to 60% of the top surface of the roofing substrate.

In some embodiments, the adhesive comprises a thickness from 10 mils to 100 mils.

In some embodiments, the adhesive is a moisture-cure adhesive.

In some embodiments, the method of installation does not include applying heat to the adhesive.

In some embodiments, the adhesive comprises a viscosity from 500 cp to 500,000 cp at 73 deg. C.

In some embodiments, the roofing substrate is a low slope roofing substrate.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced. Like reference numbers represent like parts throughout.

FIG. 1 depicts an exemplary embodiment of at least a portion of a roofing system.

FIG. 2 depicts an exemplary embodiment of at least a portion of a roofing system.

FIG. 3 depicts an exemplary embodiment of at least a portion of a roofing system.

FIGS. 4A-4B depict an exemplary embodiment of at least a portion of a prior art roofing system.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, terms such as “comprising” “including,” and “having” do not limit the scope of a specific claim to the materials or steps recited by the claim.

All prior patents, publications, and test methods referenced herein are incorporated by reference in their entireties.

As used herein, “roofing substrate” refers to a plywood substrate, a glass substrate, a fiberglass substrate, (e.g., a fiberglass mat), a cellulosic substrate, an underlayment, a roofing membrane (e.g., a thermoplastic polyolefin (TPO) or polyvinyl chloride (PVC) membrane), a roof deck, a photovoltaic (PV) panel, a modified bitumen (MODBIT) substrate, a roll good, concrete, gypsum cover panel, foam insulation, asphaltic panel, mineral wool, or any combination thereof. In some embodiments, the at least one roof substrate comprises a roof deck.

As used herein, “low slope roofing substrate” any roofing substrate that is disposed on a roof having a pitch of Y/X, where Y and X are in a ratio of less than 4:12.

As used herein, “venting channel” refers to a pathway that permits moisture to be expelled.

As used herein, “spatter pattern” refers to a randomized pattern of a liquid formed by spraying the liquid on a surface, splashing the liquid on a surface, or any combination thereof.

As used herein, “randomized pattern of adhesive” includes an adhesive applied with no discernable or specified pattern, or an adhesive that, once applied, appears to have no discernible or specified pattern.

As used here, “silane modified polymer” is any is any organic polymer that has been substituted with at least one silane group. In some embodiments, a silane modified polymer is a silane terminated polymer.

As used herein, “a silane terminated polymer” is a silane modified polymer where the substitution of the at least one silane group is at an end of a chain of the polymer backbone.

As used herein, “silane” is any compound having the general formula SiₙR₂ₙ₊₂, where R is hydrogen, an organic group, or any combination thereof. As used herein, a “silane” may also include any version of the aforementioned formula where at least one of the R groups is substituted with an organic group. In some embodiments, the silane is unsubstituted, such that all of the R groups may be the same. In some embodiments, the silane is substituted such that some of the R groups may be the same while others may differ from each other. In some embodiments, the silane is substituted such that all of the R groups are different. Examples of at least one substituent R group may include, but is not limited to at least one amino group (in the non-limiting case of an aminosilane) and at least one methoxy group (in the non-limiting case of a methoxysilane). In some embodiments, a silane may also encompass a bipodal silane.

As used herein, a “bipodal silane” is a silane having the general formula R₃Si—R—SiR₃.

As used herein, “concrete” means standard structural concrete, lightweight structural concrete, lightweight insulating concrete, or any combination thereof.

As used herein, “adhere,” “adheres,” or “adhered” means that two surfaces are attached to one another via an adhesive so as to have a wind uplift rating above 30 psf when tested according to FM 4474.

Some embodiments of the present disclosure are directed to a roofing system. In some embodiments, the roofing system comprises a roofing substrate. In some embodiments, the roofing substrate is a low slope roofing substrate. In some embodiments, the roofing substrate comprises concrete. In some embodiments, the roofing substrate comprises a top surface and a bottom surface.

In some embodiments, the roofing system comprises a roofing membrane. In some embodiments, the roofing membrane comprises thermoplastic polyolefin (TPO), polyvinyl chloride (PVC), Styrene-Butadien-Styrene (SBS) modified bitumen, polymethylmethacrylate (PMMA), Atactic Polypropylene (APP) modified bitumen, Styrene-Ethylene-Butylene-Styrene (SEBS) modified bitumen, ethylene propylene diene terpolymer (EPDM), or any combination thereof.

In some embodiments, the roofing system comprises an adhesive. In some embodiments, the adhesive may be a suitable adhesive that may be configured to adhere the roofing membrane to the roofing substrate. In some embodiments, the adhesive is a moisture-cure adhesive. In some embodiments, the adhesive comprises polyolefin polymer, poly-alpha-olefin (APAO/APO) polymer, Butyl, SIS, SBS, SEBS, SBR, ethylene vinyl acetate, poly vinyl acetate, acrylic adhesives, polyurethane, silane terminated polymer, asphaltic adhesives, hot melt adhesives, non-asphaltic adhesives, or any combination thereof.

In some embodiments, the adhesive comprises a viscosity from 500 cp to 500,000 cp at 73 deg. C. In some embodiments, the adhesive comprises a viscosity from 20,000 cp to 500,000 cp, from 40,000 cp to 500,000 cp, from 60,000 cp to 500,000 cp, from 80,000 cp to 500,000 cp, from 100,000 cp to 500,000 cp, from 120,000 cp to 500,000 cpm from 140,000 cp to 500,000 cp, from 160,000 cp to 500,000 cp, from 180,000 cp to 500,000 cp, from 200,000 cp to 500,000 cp, from 220,000 cp to 500,000 cp, from 240,000 cp to 500,000 cp, from 260,000 cp to 500,000 cp, from 280,000 cp to 500,000 cp, from 300,000 cp to 500,000 cp, from 320,000 cp to 500,000 cp, from 340,000 cp to 500,000 cp, from 360,000 cp to 500,000 cp, from 380,000 cp to 500,000 cp, from 400,000 cp to 500,000 cp, from 400,000 cp to 500,000 cp, from 420,000 cp to 500,000 cp, from 440,000 cp to 500,000 cp, from 460,000 cp to 500,000 cp, or from 480,000 cp to 500,000 cp at 73 deg. C.

In some embodiments, the adhesive comprises a viscosity from 500 cp to 480,000 cp, from 500 cp to 460,000 cp, from 500 cp to 440,000 cp, from 500 cp to 420,000 cp, from 500 cp to 400,000 cp, from 500 cp to 380,000 cp, from 500 cp to 360,000 cp, from 500 cp to 340,000 cp, from 500 cp to 320,000 cp, from 500 cp to 300,000 cp, from 500 cp to 280,000 cp, from 500 cp to 260,000 cp, from 500 cp to 240,000 cp, from 500 cp to 220,000 cp, from 500 cp to 200,000 cp, from 500 cp to 180,000 cp, from 500 cp to 160,000 cp, from 500 cp to 140,000 cp, from 500 cp to 120,000 cp, from 500 cp to 100,000 cp, from 500 cp to 80,000 cp, from 500 cp to 60,000 cp, from 500 cp to 40,000 cp, or from 500 cp to 20,000 cp at 73 deg. C.

In some embodiments, the adhesive comprises a viscosity from 20,000 cp to 480,000 cp, from 40,000 cp to 440,000 cp, from 60,000 cp to 420,000 cp, from 80,000 cp to 400,000 cp, from 100,000 cp to 380,000 cp, from 120,000 cp to 360,000 cp, from 140,000 cp to 340,000 cp, from 160,000 cp to 320,000 cp, from 180,000 cp to 300,000 cp, from 200,000 cp to 280,000 cp, or from 220,000 cp to 260,000 cp at 73 deg. C.

In some embodiments, the adhesive on the top surface of the roofing substrate comprises a thickness from 10 mils to 100 mils, from 20 mils to 100 mils, from 30 mils to 100 mils, from 40 mils to 100 mils, from 50 mils to 100 mils, from 60 mils to 100 mils, from 70 mils to 100 mils, from 80 mils to 100 mils, from 90 mils to 100 mils, from 10 mils to 90 mils, from 10 mils to 80 mils, from 10 mils to 70 mils, from 10 mils to 60 mils, from 10 mils to 50 mils, from 10 mils to 40 mils, from 10 mils to 30 mils, from 10 mils to 20 mils, from 20 mils to 90 mils, from 30 mils to 80 mils, from 40 mils to 70 mils, or from 50 mils to 60 mils.

In some embodiments, the adhesive completely covers the top surface of the roofing substrate. In some embodiments, the adhesive covers less than 100% of the top surface of the roofing substrate. In some embodiments, the adhesive covers from 30% to 70% of the top surface of the roofing substrate. In some embodiments, the adhesive covers from 35% to 70%, from 40% to 70%, from 45% to 70%, from 50% to 70%, from 55% to 70%, from 60% to 70%, from 65% to 70%, from 30% to 65%, from 30% to 60%, from 30% to 55%, from 30% to 50%, from 30% to 45%, from 30% to 40%, from 30% to 35%, from 35% to 65%, from 40% to 60%, or from 45% to 55% of the top surface of the roofing substrate.

In some embodiments, the adhesive is formed in a pattern on the top surface of the roofing substrate. In some embodiments, the pattern is a suitable pattern having at least one venting channel. In some embodiments, the pattern is a suitable pattern having a plurality of venting channels. In some embodiments, the pattern may include strips, dashes, dots, or any combination thereof. In some embodiments, the pattern is a randomized pattern. In some embodiments, the pattern is a randomized pattern of a liquid formed by spraying the liquid on a surface, splashing the liquid on a surface, or any combination thereof. In some embodiments, the randomized pattern is a spatter pattern.

In some embodiments, a bond strength between the roofing membrane and the roofing substrate such that there is a wind uplift rating above 30 psf when tested according to FM 4474.

In some embodiments, a bond strength between the roofing membrane and the roofing substrate may be between 270 psf and 315 psf when the adhesive is applied in a spatter pattern.

Some embodiments of the present disclosure are directed to a method of installation. In some embodiments, the method comprises obtaining an adhesive described herein. In some embodiments, the method comprises obtaining a roofing membrane described herein.

In some embodiments, the method includes applying the adhesive to a top surface of a roofing substrate. In some embodiments, the adhesive is applied using air pressure, spraying, splashing, or any combination thereof.

In some embodiments, the adhesive is applied so as to completely cover the top surface of the roofing substrate. In some embodiments, the adhesive is applied so as to cover less than 100% of the top surface of the roofing substrate. In some embodiments, the adhesive is applied so as to cover from 30% to 70% of the top surface of the roofing substrate. In some embodiments, the adhesive is applied so as to cover from 35% to 70%, from 40% to 70%, from 45% to 70%, from 50% to 70%, from 55% to 70%, from 60% to 70%, from 65% to 70%, from 30% to 65%, from 30% to 60%, from 30% to 55%, from 30% to 50%, from 30% to 45%, from 30% to 40%, from 30% to 35%, from 35% to 65%, from 40% to 60%, or from 45% to 55% of the top surface of the roofing substrate.

In some embodiments, the adhesive is applied on the top surface of the roofing substrate so as to comprise a thickness from 10 mils to 100 mils, from 20 mils to 100 mils, from 30 mils to 100 mils, from 40 mils to 100 mils, from 50 mils to 100 mils, from 60 mils to 100 mils, from 70 mils to 100 mils, from 80 mils to 100 mils, from 90 mils to 100 mils, from 10 mils to 90 mils, from 10 mils to 80 mils, from 10 mils to 70 mils, from 10 mils to 60 mils, from 10 mils to 50 mils, from 10 mils to 40 mils, from 10 mils to 30 mils, from 10 mils to 20 mils, from 20 mils to 90 mils, from 30 mils to 80 mils, from 40 mils to 70 mils, or from 50 mils to 60 mils.

In some embodiments, the adhesive is applied to the top surface of the roofing substrate so as to form a pattern described herein. In some embodiments, the adhesive is applied to the top surface of the roofing substrate so as to form a pattern comprising at least one venting channel. In some embodiments, the adhesive is applied to the top surface of the roofing substrate so as to form a pattern comprising a plurality of venting channels. In some embodiments, the adhesive is applied to the top surface of the roofing substrate so as to form a spatter pattern comprising venting channels. In some embodiments, the spatter pattern comprises an increased number of venting channels as compared to a striped pattern.

In some embodiments, the method comprises adhering the roofing membrane to the roofing substrate so as to form a roofing system. In some embodiments, adhering the roofing membrane to the roofing substrate comprises forming a bond strength between the roofing membrane and the roofing substrate such that there is a wind uplift rating above 30 psf when tested according to FM 4474.

In some embodiments, adhering the roofing membrane to the roofing substrate includes compressing the roofing membrane to the top surface of the roofing substrate. In some embodiments, compressing the roofing membrane to the top surface of the roofing substrate comprises applying pressure in an amount that is sufficient to flatten the adhesive. In some embodiments, compressing the roofing membrane to the top surface of the roofing substrate may comprise using suitable tools so as to adhere the roofing membrane to the top surface of the roofing substrate. For example, and without limitation, the method may include using a rake, a roller, or any combination thereof to compress the roofing membrane to the top surface of the roofing substrate.

In some embodiments, the method comprises curing the adhesive. In some embodiments, curing the adhesive comprises applying heat to the adhesive. In some embodiments, curing the adhesive does not include applying heat to the adhesive. In some embodiments, the adhesive is a moisture-cure adhesive.

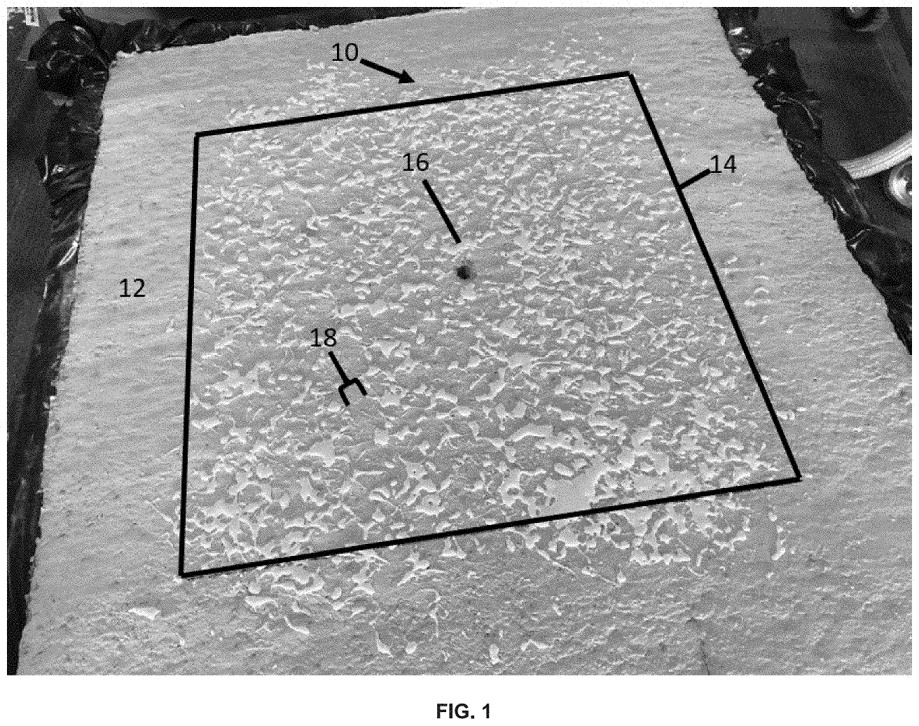

The present disclosure will now be described with reference to non-limiting exemplary embodiments depicted in FIGS. 1-3.

FIG. 1 depicts an exemplary embodiment of at least a portion of a roofing system 10. As shown in FIG. 1, the roofing system 10 includes a roofing substrate 12. In the exemplary embodiment of FIG. 1, the roofing substrate 12 comprises concrete. In the exemplary embodiment of FIG. 1, the concrete of the roofing substrate 12 comprises standard structure concrete, lightweight structural concrete, lightweight insulating concrete, or any combination thereof. In the exemplary embodiment of FIG. 1, the roofing substrate 12 comprises a top surface 14. In the exemplary embodiment of FIG. 1, there is an adhesive 16 on the top surface 14 of the roofing substrate 12. In the exemplary embodiment of FIG. 1, the adhesive 16 comprises a silane-terminated polymer. In the exemplary embodiment of FIG. 1, the silane-terminated polymer comprises a silane modified polymer, as defined herein, where the substitution of the at least one silane group is at an end of a chain of the polymer backbone. In the exemplary embodiment of FIG. 1, siliane in the silane-terminated polymer is as defined herein. In the exemplary embodiment of FIG. 1, the adhesive 16 covers approximately 40% of the top surface 14 of the roofing substrate 12. In the exemplary embodiment of FIG. 1, the adhesive 16 is formed in a spatter pattern. As shown in FIG. 1, there are a plurality of venting channels 18 formed in the spatter pattern of the adhesive 16.

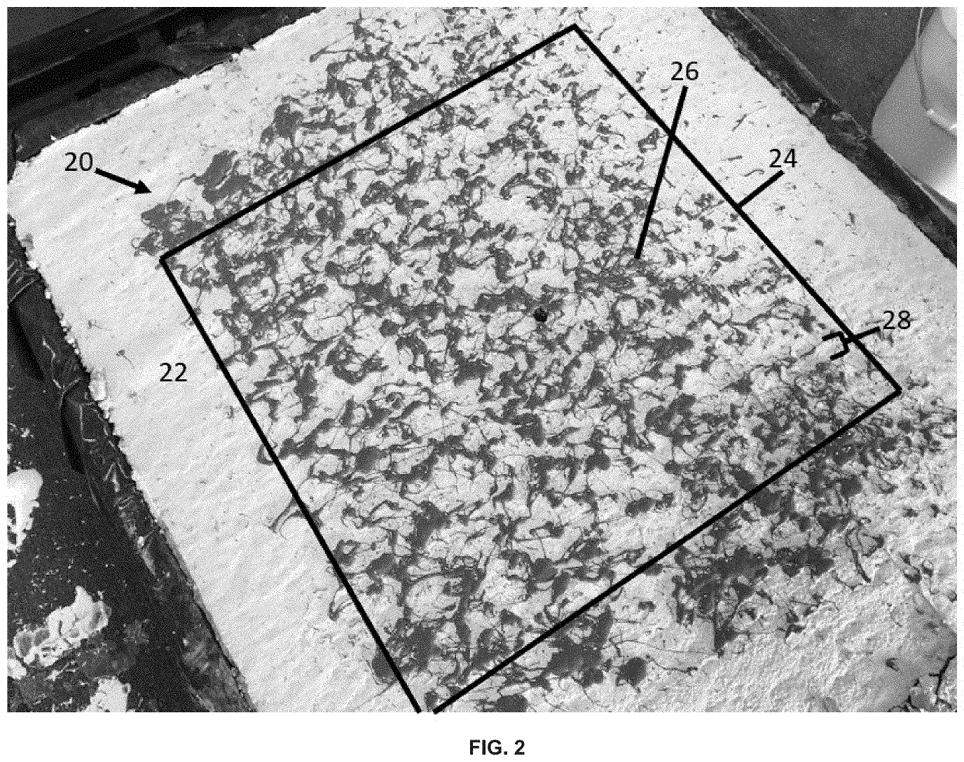

FIG. 2 depicts an exemplary embodiment of at least a portion of a roofing system 20. As shown in FIG. 2, the roofing system 20 includes a roofing substrate 22. In the exemplary embodiment of FIG. 2, the roofing substrate 22 comprises concrete. In the exemplary embodiment of FIG. 2, the roofing substrate 22 comprises a top surface 24. In the exemplary embodiment of FIG. 2, there is an adhesive 26 on the top surface 24 of the roofing substrate 22. In the exemplary embodiment of FIG. 2, the adhesive 26 comprises a silane terminated polymer. In the exemplary embodiment of FIG. 2, the adhesive 26 covers approximately 42% of the top surface 24 of the roofing substrate 22. In the exemplary embodiment of FIG. 2, the adhesive 26 is formed in a spatter pattern. As shown in FIG. 2, there area plurality of venting channels 28 formed in the spatter pattern of the adhesive 26.

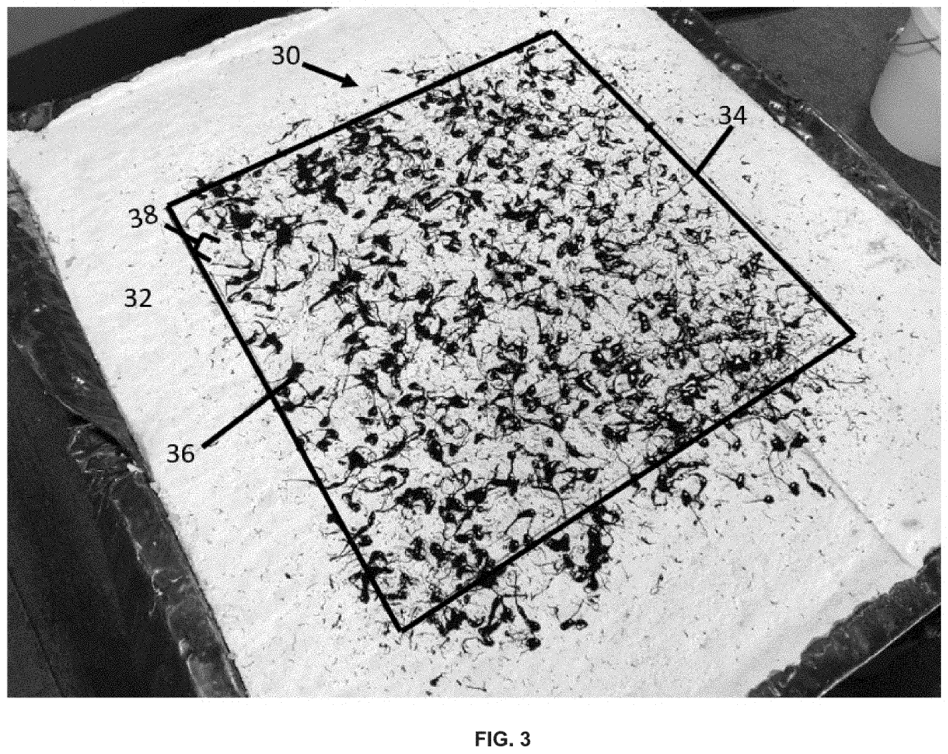

FIG. 3 depicts an exemplary embodiment of at least a portion of a roofing system 30. As shown in FIG. 3, the roofing system 30 includes a roofing substrate 32. In the exemplary embodiment of FIG. 3, the roofing substrate 32 comprises concrete. In the exemplary embodiment of FIG. 3, the roofing substrate 32 comprises a top surface 34. In the exemplary embodiment of FIG. 3, there is an adhesive 36 on the top surface 34 of the roofing substrate 32. In the exemplary embodiment of FIG. 3, the adhesive 36 comprises a silane terminated polymer. In the exemplary embodiment of FIG. 3, the adhesive 36 covers approximately 37% of the top surface 34 of the roofing substrate 32. In the exemplary embodiment of FIG. 3, the adhesive 36 is formed in a spatter pattern. As shown in FIG. 3, there are a plurality of venting channels 38 formed in the spatter pattern of the adhesive 36.

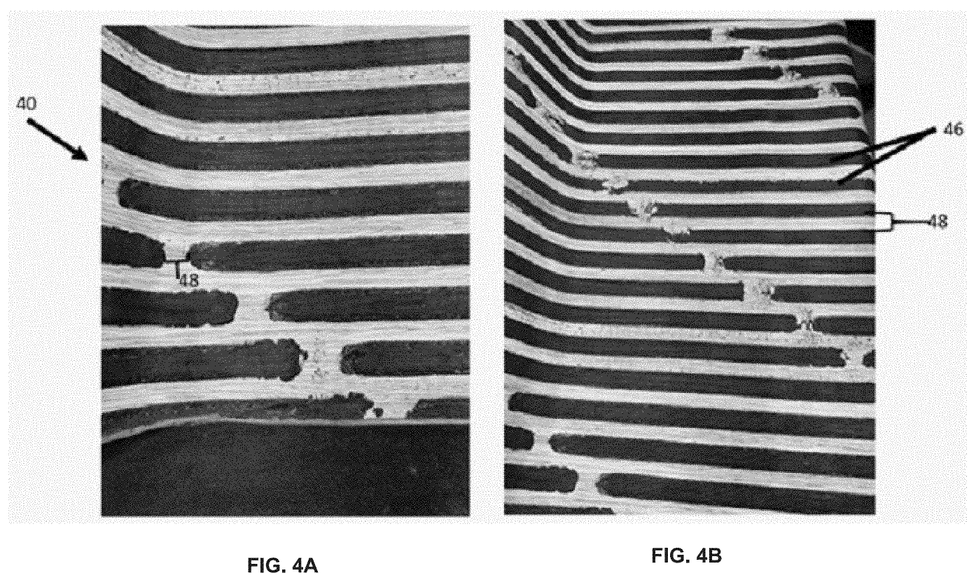

FIGS. 4A-4B depict an exemplary embodiment of at least a portion of a prior art roofing system 40.

As shown in FIGS. 4A-4B, in the exemplary embodiment of the prior art roofing system 40, the adhesive is formed in a striped pattern 46. A comparison of FIGS. 4A-4B to FIGS. 1-3 shows that in the exemplary embodiments of FIGS. 1-3, which show examples of randomized patterns, the roofing systems 10, 20, 30 with the spatter pattern adhesives 16, 26, 36 may comprise more venting channels 18, 28, 38 than the prior art roofing system 40 with the stripe pattern adhesive 46 forming venting channels 48.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A roofing system comprising:
a roofing substrate,
wherein the roofing substrate comprises concrete, and
wherein the roofing substrate comprises a top surface;
a roofing membrane adhered to the roofing substrate; and
an adhesive on the top surface of the roofing substrate,
wherein the adhesive adheres the roofing membrane to the roofing substrate,
wherein the adhesive has a pattern,
wherein the adhesive comprises a silane-terminated polymer, and
wherein the pattern comprises a spatter pattern.

2. The roofing system according to claim 1, wherein the spatter pattern comprises a randomized pattern of adhesive.

3. The roofing system according to claim 1, wherein the adhesive covers from 40% to 60% of the top surface of the roofing substrate.

4. The roofing system according to claim 1, wherein the adhesive is a moisture-cure adhesive.

5. The roofing system according to claim 1, wherein the roofing membrane comprises thermoplastic polyolefin (TPO), polyvinyl chloride (PVC), Styrene-Butadien-Styrene (SBS) modified bitumen, polymethylmethacrylate (PMMA), or any combination thereof.

6. The roofing system according to claim 1, wherein the adhesive comprises a thickness from 10 mils to 100 mils.

7. The roofing system according to claim 1, wherein the roofing substrate is a low slope roofing substrate.

8. A method of installation comprising:
obtaining an adhesive,
wherein the adhesive comprises a silane-terminated polymer;
obtaining a roofing membrane;
applying the adhesive to a top surface of a roofing substrate so as to form a pattern on the top surface of the roofing substrate,
wherein the roofing substrate comprises concrete, and
wherein the pattern comprises a spatter pattern; and
adhering the roofing membrane to the roofing substrate so as to form a roofing system.

9. The method according to claim 8, wherein the spatter pattern comprises a randomized pattern of adhesive.

10. The method according to claim 8, wherein the adhesive covers from 40% to 60% of the top surface of the roofing substrate.

11. The method according to claim 8, wherein the adhesive is a moisture-cure adhesive.

12. The method according to claim 8, wherein the adhesive comprises a thickness from 10 mils to 100 mils.

13. The method according to claim 8, wherein the adhesive comprises a viscosity from 500 cp to 500,000 cp at 73 deg. C.

14. The method according to claim 8, further comprising:
compressing the roofing membrane to the roofing substrate.

15. The method according to claim 14, wherein compressing the roofing membrane comprises compressing the roofing membrane with a rake or a roller.

16. The method according to claim 8, wherein the method does not include applying heat to the adhesive.

17. The method according to claim 8, wherein the roofing membrane comprises thermoplastic polyolefin (TPO), polyvinyl chloride (PVC), Styrene-Butadien-Styrene (SBS) modified bitumen, polymethylmethacrylate (PMMA), or any combination thereof.

18. The method according to claim 8, wherein the roofing substrate is a low slope substrate.

19. The method according to claim 8, wherein applying the adhesive comprises forming venting channels between the roofing membrane and the roofing substrate.

20. The method according to claim 8, wherein applying the adhesive to the top surface of the roofing substrate comprises using air pressure, spraying, splashing, or any combination thereof.
